(19) United States
(12) Patent Application Publication
(10) Pub. No.: US 2026/0361629 A1
(43) Pub. Date: Nov. 12, 2026

(54) GRAPH NEURAL NETWORK DRIVEN CONFLICT DETECTION

(71) Applicant: Dell Products L.P., Round Rock, TX (US)

(72) Inventors: Hoda Dehghan, Kanata (CA); Mohammad Alavirad, Kanata (CA)

(21) Appl. No.: 19/201,415

(22) Filed: May 7, 2025

(51) Int. Cl. H04L 43/08; G06N 3/042; H04L 41/0873; H04L 41/16

(52) U.S. Cl. CPC H04L 43/08; G06N 3/042; H04L 41/0873; H04L 41/16

(57) ABSTRACT

The subject technologies relate to graph neural network (GNN)-driven conflict detection. An example method facilitates GNN-driven conflict detection and includes generating representations of applications enabled for use within a radio access network (RAN), the representations including nodes of a graph structure and application feature sets; determining, based on an output of a GNN as applied to the nodes of the graph structure and the application feature sets, a probability that a first application of the applications is going to perform a first action that conflicts with a second action taken by a second application of the applications; and, in response to the probability being determined to be greater than a threshold probability, restricting a rate at which the first application is able to issue commands within the RAN.

### BACKGROUND

In the rapidly evolving telecommunications sector, the Open Radio Access Network (Open RAN or O-RAN) architecture is a significant development that enables enhanced flexibility, interoperability, and scalability in network management. Central to this architecture are RAN Intelligent Controllers (RICs), which can function across the non-real time (non-RT), near-RT, and RT levels to host diverse, vendor-agnostic applications.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an example implementation, a system is described herein. The system can include at least one processor and at least one memory that stores executable instructions that, when executed by the at least one processor, facilitate performance of operations. The operations can include representing respective ones of a group of applications enabled for use within a radio access network (RAN) as graph nodes and corresponding application feature sets. The operations can also include, based on an output of a graph neural network (GNN) as applied to the graph nodes and the application feature sets, determining a probability that a first application of the group of applications is going to perform a first action that conflicts with a second action taken by a second application of the group of applications. The operations can further include, in response to the probability being determined to be greater than a threshold probability, restricting a rate at which the first application is able to issue commands within the RAN.

In another example implementation, a method is described herein. The method can include generating, by a system including at least one processor, representations of applications enabled for use within a RAN, the representations including nodes of a graph structure and application feature sets. The method can further include determining, by the system based on an output of a GNN as applied to the nodes of the graph structure and the application feature sets, a probability that a first application of the applications is going to perform a first action that conflicts with a second action taken by a second application of the applications. The method can additionally include, in response to the probability being determined to be greater than a threshold probability, restricting, by the system, a rate at which the first application is able to issue commands within the RAN.

In an additional example implementation, a non-transitory machine-readable medium is described herein that can include instructions that, when executed by at least one processor, facilitate performance of operations. The operations can include generating application data corresponding to applications registered for use within a RAN, the application data including graph nodes and respective groups of application features corresponding to respective ones of the applications; based on an output of a GNN as applied to the graph nodes and the respective groups of application features, determining a probability that a first one of the applications will perform a first action that conflicts with a second action taken by a second one of the applications; and, based on the probability being greater than a threshold probability, restricting a permitted rate at which the first one of the applications is able to issue commands within the RAN.

### DESCRIPTION OF DRAWINGS

Various non-limiting embodiments of the subject disclosure are described with reference to the following figures, wherein like reference numerals refer to like parts throughout unless otherwise specified.

FIGS. 1-6 are block diagrams of respective systems that facilitate GNN-driven conflict detection in accordance with various implementations described herein.

FIG. 7 is a diagram depicting an example network environment in which various implementations described herein can function.

FIG. 8 is a diagram depicting an example procedure that can be utilized in connection with one or more implementations described herein.

FIGS. 9-10 are flow diagrams of respective methods that facilitate GNN-driven conflict detection in accordance with various implementations described herein.

FIG. 11 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As mentioned in the background, RAN Intelligent Controllers (RICs) are part of the Open RAN (O-RAN) architecture and can function across the non-real time (non-RT), near-RT, and RT levels to host diverse, vendor-agnostic applications. While applications hosted by these RICs are intended to optimize network performance, different applications can often take conflicting actions due to divergent application objectives and/or strategies.

In consideration of these and/or other issues with conventional systems, various implementations described herein relate to techniques for utilizing graph neural network (GNN) driven techniques to identify and mitigate conflicts between applications enabled for use within a radio access network (RAN). While some example implementations are described in the context of an O-RAN architecture, it is noted that these examples are not intended to limit the scope of this description or the claimed subject matter unless explicitly stated otherwise. For instance, in addition to or in place of an O-RAN architecture, various implementations as described herein could also be used to detect and mitigate conflict between applications in other RAN architectures, such as an artificial intelligence (AI) RAN (AI-RAN) architecture and/or any other suitable RAN architecture(s) either presently existing or developed in the future.

As noted above, a RAN can leverage respective applications to perform optimizations and/or other actions on various timescales, including the non-RT, near-RT, and RT levels. However, actions taken by a given application associated with a RAN can potentially conflict with actions of other applications, particularly in the case where a RAN utilizes applications from multiple vendors. These conflicts can materialize in multiple different forms. For instance, direct conflicts can arise when applications issue contradictory commands for the same resources, indirect conflicts arise from hidden dependencies between applications influencing adjacent RAN operations, and implicit conflicts can occur when applications optimize different metrics independently, leading to unintended network performance degradation. These conflict types are described in additional detail below.

To address these conflicts, various implementations described herein can utilize a GNN-based conflict detection approach. For instance, implementations as described herein can leverage the capabilities of GNNs to analyze and comprehend the complex web of interactions and dependencies within applications running in a network environment, enabling detection of both overt and covert conflicts as well as prediction of potential conflicts before they materialize.

A GNN-based approach as described in further detail below can operate across various timescales to provide a comprehensive solution for real-time conflict detection. Implementations as described herein can analyze network parameters, application behaviors, and their interdependencies to identify potential conflicts. In doing so, implementations as described herein can maintaining high standards of network performance and reliability in a RAN ecosystem.

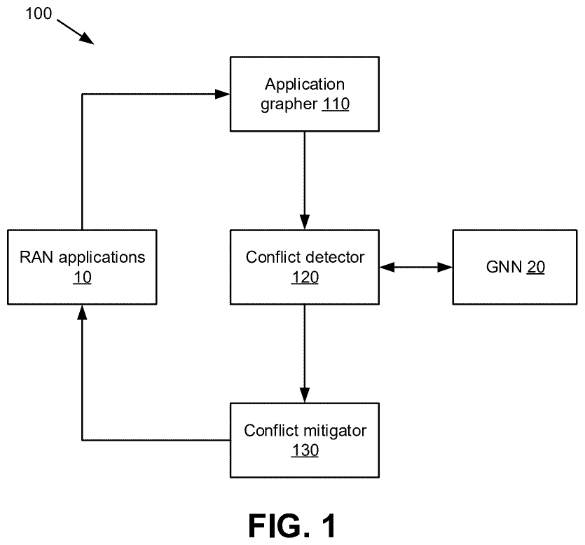

With reference now to the drawings, FIG. 1 illustrates a block diagram of a system 100 that facilitates GNN-driven conflict detection in accordance with various implementations described herein. System 100 as shown in FIG. 1 includes executable components, e.g., an application grapher 110, a conflict detector 120, and a conflict mitigator 130, each of which can operate as described in further detail below.

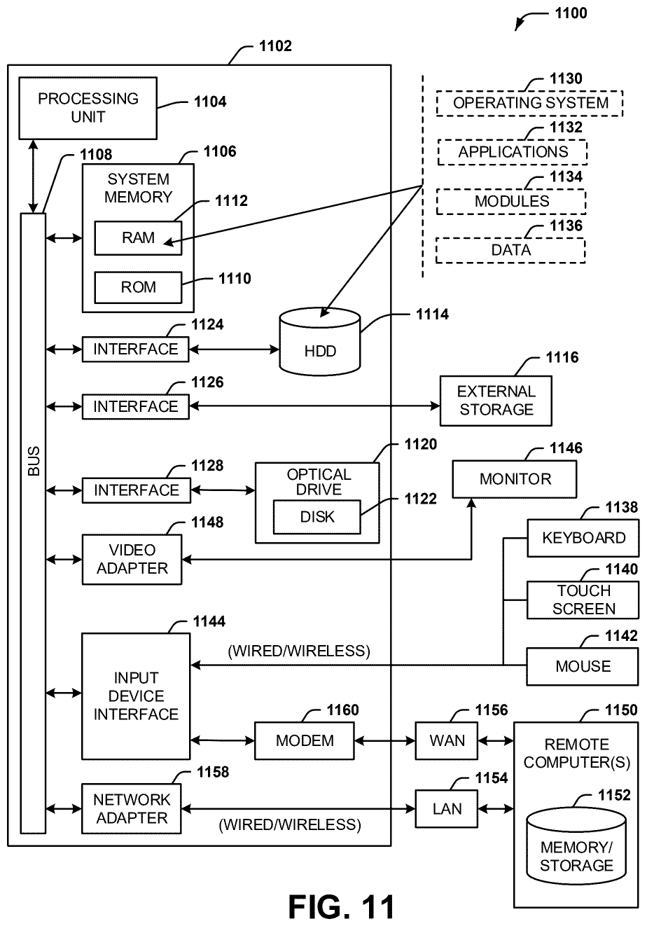

In an example implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIG. 11. In some implementations, the executable components 110, 120, 130 of system 100, and/or other system elements, can communicate with each other via a bus and/or other components that provide intercommunication between various elements of system 100.

Additionally, it is noted that the functionality of the respective components shown and described herein can be implemented via a single computing device and/or a combination of devices. For instance, in various implementations, the application grapher 110 shown in FIG. 1 could be implemented via a first device, the conflict detector 120 could be implemented via the first device or a second device, and the conflict mitigator 130 could be implemented via the first device, the second device, or a third device. Also, or alternatively, the functionality of a single component could be divided among multiple devices in some implementations.

As will be described in further detail below, system 100 as shown in FIG. 1 can be utilized to manage and mitigate conflicts between respective ones of a group of applications enabled for use within a RAN, denoted in FIG. 1 as RAN applications 10. System 100 can facilitate detection and mitigation of multiple types of conflicts between applications, such as the following:

Direct conflicts: Direct conflicts are those that are immediately discernible, e.g., due to being overt and typically involving competing requests from multiple applications for the same resources or parameter settings. Examples of direct conflicts include instances where multiple applications request different settings for one or more control targets; situations where a new request from an application potentially clashes with an existing configuration or a previous request from the same or a different application, in which case the conflict emerges with the introduction of the new request; scenarios where the cumulative resource demands from different applications surpass the available RAN resources, leading to a direct resource allocation conflict; and/or other similar scenarios.

Indirect conflicts: Unlike direct conflicts, indirect conflicts are not immediately apparent. These arise due to subtle dependencies or interactions among the target parameters and resources of different applications. While such conflicts may not be directly observable as in the case of direct conflicts, potential indirect conflicts can nonetheless be identified based on the interplay of these dependencies. An illustrative example of an indirect conflict is when different applications aim to optimize the same system metric but target different parameters for this purpose. Although this does not lead to direct conflicting parameter settings, the configuration by one application can inadvertently impact the system metric, indirectly affecting the parameter targeted by another application. For instance, adjustments in antenna tilts and cell individual offset (CIO) are separate control actions, yet both can influence the handover process, leading to an indirect conflict.

Implicit conflicts: Implicit conflicts are the most elusive, characterized by the absence of direct visibility and even indiscernible dependencies between multiple applications. In such scenarios, each application independently optimizes different metrics using distinct parameters, with no apparent conflict in parameter settings or resource allocation. However, the optimization of one metric by an application can inadvertently undermine the metrics optimized by other applications. This form of conflict is subtle and deep-seated, as the adverse effects are often indirect and not immediately observable. A case in point is the optimization of throughput metrics for guaranteed bit rate (GBR) users, which might inadvertently impair the metrics concerning non-GBR users or the overall cell throughput, manifesting an implicit conflict.

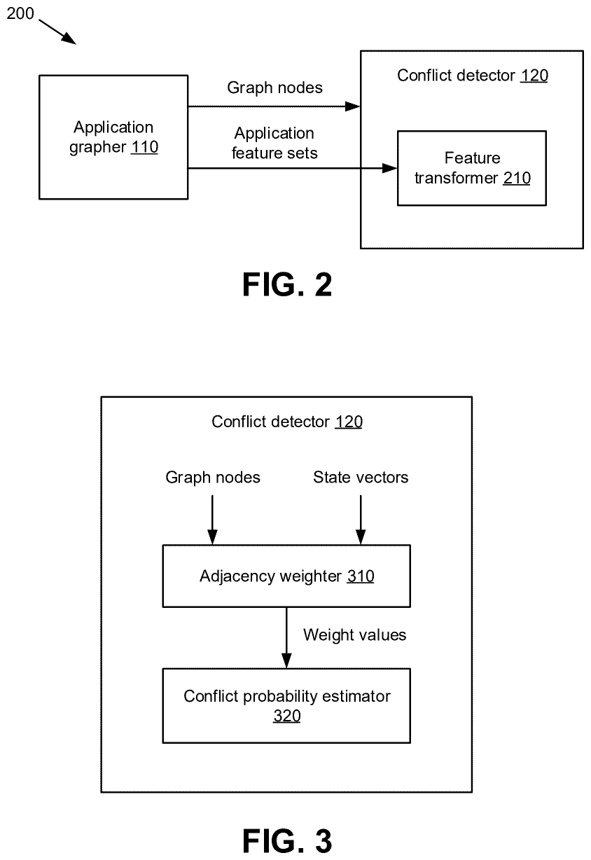

With reference now to the components of system 100, the application grapher 110 can represent respective ones of a group of applications enabled for use within a RAN, denoted in FIG. 1 as RAN applications 10, as graph nodes and corresponding application feature sets. In an implementation, the graph nodes can constitute nodes of a graph structure that can be provided to a GNN 20 for further processing as described below. In addition, the structure and content of the application feature sets that can be generated by the application grapher 110 are described in further detail below with reference to FIG. 2.

The conflict detector 120 of system 100 can, based on a output of an associated GNN 20 as applied to the graph nodes and the application feature sets generated by the application grapher 110, determine a probability of conflict between respective ones of the RAN applications 10, e.g., a probability that a first application of the RAN applications 10 is going to perform a first action that conflicts with a second action taken by a second application of the RAN applications 10. As will be described in further detail below, the conflict detector 120 can be configured to detect multiple types of conflicts, including direct conflicts as well as other, more subtle types of conflicts that are more difficult to detect via conventional means. It is noted that while the GNN 20 is shown in FIG. 1 as separate from the conflict detector 120, the GNN 20 could, in some implementations, be integrated into the conflict detector 120 (and/or the application grapher 110) as a single functional unit.

In general, a GNN is a neural network that operates on graph-structured data, which inherently defies the traditional Euclidean framework. Such data is typically represented as a graph G=(V,E), where V is a set of nodes and E is a set of edges connecting those nodes. Each node vᵢ∈V and edge eᵢⱼ=(vᵢ,vⱼ)∈E encapsulate the entities and their interrelations within the network, offering a holistic view of network dynamics. GNNs are particularly adept at handling the complex, non-linear relationships that are characteristic of O-RAN systems and/or other network environments. By representing each RAN application 10 as a graph node with a rich feature set, the GNN 20 shown in FIG. 1 can capture the intricate dependencies and interactions that may lead to conflicts.

The conflict mitigator 130 of system 100 can, in response to a probability of conflict as determined by the conflict detector 120 being greater than a defined threshold probability, restrict a rate at which an application of the RAN applications 10 is able to issue commands within the associated RAN. For instance, based on determining that a given RAN application 10 is likely to cause conflicts with other RAN applications, the conflict mitigator 130 can limit the number of commands that can be issued by the RAN application 10 within a time interval, prevent the application from issuing any commands to the RAN for a defined amount of time, cause commands issued by other applications to be prioritized over commands issued by the application, and/or other appropriate actions. In taking these and/or other actions, the conflict mitigator 130 can improve the performance of an associated RAN by directly controlling the ability of one or more RAN applications 10 found to be causing conflicts in the network, and/or network devices on which said RAN applications 10 reside, to continue issuing conflicting commands.

By operating as described above, system 100 can provide improved conflict management for RAN applications 10, such as O-RAN applications (e.g., xApps, rApps, etc.) running on RAN intelligent controllers (RICs) or other suitable devices. It is noted, however, that system 100 can also be applied more generally to any control platform that desirably deploys multiple potentially conflicting applications. Additionally, system 100 as shown in FIG. 1 can provide a solution to address the complex challenges that a diverse, vendor-agnostic application landscape can present in conflict management. These challenges can include, e.g., the following:

Diverse application objectives leading to conflicts: Each RAN application 10 shown in FIG. 1 can be designed to optimize specific network parameters or Key Performance Indicators (KPIs). These applications, while individually efficient, can often have conflicting objectives and/or operational strategies. For example, one application may prioritize bandwidth optimization for high-demand users, while another may focus on equitable bandwidth distribution across all users. Such divergent goals can lead to direct conflicts in network management, adversely affecting overall network performance.

Multi-vendor environment worsening conflict scenarios: The open and multi-vendor nature of some network architectures, such as O-RAN or the like, can further complicate conflict management. For instance, different vendors may deploy applications with varying operational logics and optimization goals. This heterogeneity, though beneficial for innovation and flexibility, can inadvertently result in conflicting actions when these applications interact within the same environment.

Inadequacy of traditional conflict detection and mitigation mechanisms: Traditional conflict management approaches are often inadequate in identifying and resolving the intricate and dynamic conflicts that arise in such a diverse network environment. There is a need in the art for advanced mechanisms that can intelligently detect, predict, and mitigate conflicts to ensure seamless network operation. These mechanisms should desirably be capable of understanding the complex interdependencies and interactions among various applications and their impact on network performance.

Complexity of indirect and implicit conflicts: As noted above, beyond direct conflicts, indirect and implicit conflicts pose a significant challenge. For indirect conflicts, resulting from hidden dependencies, and implicit conflicts, arising from independent optimization of different metrics, it is desirable to implement sophisticated analytical capabilities to detect and resolve such conflicts. These types of conflicts are often not immediately apparent but can have a profound impact on the network's efficiency and reliability.

To the furtherance of the above and/or related ends, various implementations described herein can provide an effective conflict detection solution that can navigate the complexities of a modern network environment, such as a multi-application, multi-vendor RIC environment in O-RAN. Implementations described herein can be capable of not only detecting and resolving overt conflicts but also identifying and addressing the more subtle and hidden conflicts that can significantly impact network performance.

To effectively address these multifaceted conflicts, various implementations described herein can utilize a GNN-based conflict detection approach. This approach leverages the power of a GNN to analyze and understand the intricate web of interactions and dependencies within a network environment. GNNs, with their exceptional ability to model complex, interconnected systems, offer a sophisticated means to not only detect both overt and covert conflicts but also predict potential conflict scenarios before they materialize.

As will be described below, implementations provided herein can utilize a GNN-based system that can operate across RIC levels, providing a comprehensive solution for conflict detection. By intelligently analyzing network parameters, application behaviors, and their interdependencies, the system can identify potential conflicts in real-time, suggest optimal resolutions, and even prevent conflicts from arising. This proactive approach to conflict management can be used to maintain the high standards of network performance and reliability expected in the O-RAN ecosystem and/or other suitable network ecosystems.

With reference now to FIG. 2, a block diagram of another system 200 that facilitates GNN-driven conflict detection is illustrated. Repetitive description of like parts described above with regard to other implementations is omitted for brevity. System 200 as shown in FIG. 2 includes an application grapher 110 and a conflict detector 120, which can operate as described above with respect to FIG. 1. The conflict detector 120 of system 200 includes a feature transformer 210, which can generate a state vector for a given application (e.g., a RAN application 10 as shown in FIG. 1) by performing a latent space transformation on an application feature set generated by the application grapher 110 that corresponds to that application. As will be described below, this state vector can relate the application to other applications (e.g., other RAN applications 10 as shown in FIG. 1) based on a determined potential for conflicts between the application and the other applications. It is noted that while the GNN 20 is not shown in FIG. 2 for simplicity of illustration, the application grapher 110 and/or conflict detector 120 could implement some or all functionality of the GNN 20 shown in FIG. 1 to facilitate performance of the operations shown in FIG. 2.

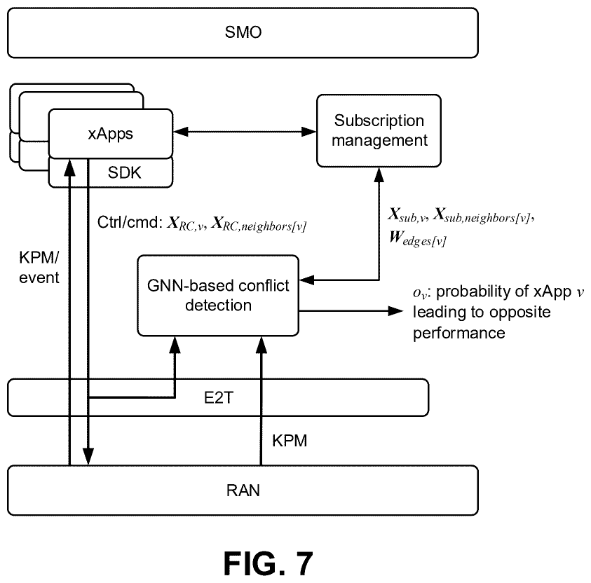

As shown by FIG. 2, the application grapher 110 of system 200 can model each application (e.g., each RAN application as shown in FIG. 1, etc.) as a graph node v, characterized by an application feature set Xᵥ=[X_{sub,v}, X_{RC,v}, X_{KPI}]. Here, X_{sub,v} is a detailed application descriptor that is representative of features of the application and/or its subscription within an associated RAN, which can be specified to a subscription management system and/or other suitable network functions upon joining and/or activating within the network. These features can include, e.g., KPIs targeted by the application, the level of control desired by the application within the network (e.g., user-level, cell-level, etc.), details regarding the manner in which the application provides commands to the network, and/or other suitable features. Subscription management for network applications is described in further detail below with reference to FIG. 7.

The term X_{RC,v} in the descriptor Xᵥ is a listing of RAN control (RC) commands and/or actions that are performable by the application and/or their properties. These properties can include, e.g., an indication of the RAN parameters (e.g., cell offset, power levels, etc.) that can be modified by the application via the provided RAN control commands. The term X_{KPI} in the descriptor Xᵥ includes real-time and historical KPI values, e.g., based on observed network performance metrics resulting from execution of the application and/or other applications. In general, the descriptor Xᵥ can include subscription information, configuration details, targeted KPI categories (e.g., coverage, capacity, energy) and sub-categories (e.g., accessibility, retainability, mobility, spectral efficiency, channel utilization, device power saving, transmission and reception point (TRP) power, distributed unit/centralized unit (DU/CU) power consumption), app classification, levels of control (user-level action, aggregate (cluster, site, sector, cell, slice)-level configuration), types of control (e.g., RC action list, RAN parameter list), and/or other suitable information. The node representation can also include other attributes detailing the node state. These and/or other attributes can be generated by other machine learning modules in addition to, or in place of, a GNN (e.g., a GNN associated with system 200).

Based on the above, the feature transformer 210 can leverage GNN functionality to transform an application feature set Xᵥ into a latent space hᵥ. This transformation can encapsulate not just the attributes of the associated node but also the aggregated information from its neighbors, allowing for the detection of complex conflict scenarios. For instance, the feature transformer 210 can, based on the output of a GNN, learn to represent each node with a state vector that contains information about its immediate environment. This state vector can be formalized as follows:

hᵥ=ƒ(Xᵥ,W_{edges[v]},h_{neighbors[v]},X_{neighbors[v]})

where W_{edges[v]} is a term used to quantify the likelihood between nodes (e.g., as will be described in further detail below), and h_{neighbors[v]} and X_{neighbors[v]} are the state vectors and feature sets for the nodes that neighbor the associated node, respectively. As used herein, the nodes that “neighbor” a given node correspond to applications that could potentially conflict with the application corresponding to the given node. As will be described in further detail below, neighboring nodes are connected in the graph structure via edges, which can be associated with parameters relating to the potential types of conflict between applications. By utilizing the above function ƒ, the conflict detector 120 can ensure that the state vector is sensitive to the potential conflicts arising from the interactions between a given node and its neighbors.

In an example implementation, the function ƒ used for latent space transformation can involve aggregating features from the neighbors of a given node and combining them with the features of that node. This process can help in encoding both local and neighborhood information into a new, latent representation of the node. In an example, latent space transformation can be performed by using a Graph Convolutional Network (GCN) layer. The GCN operates on the principle of aggregating neighbor information to update the representation of a node. In an example implementation, the function ƒ for a single layer of a GCN can be represented as follows:

$${h}_{v} = σ ( \frac{1}{\vert N ( v ) \vert + 1} C \cdot ( {x}_{v} + {\sum }_{u ∈ N ( v )} {w}_{u ν} {x}_{u} ) )$$

where hᵥ is the updated feature vector (latent space representation) of node v, σ is a non-linear activation function, C is a weight matrix (including learnable parameters of the GCN layer), xᵥ is the original feature vector of node v, N(v) represents the set of neighbors of node V, xᵤ represents the feature vector of neighbor u, and wᵤᵥ is a weighted adjacency matrix entry connecting node v to u.

The above function can aggregate the weighted features of the neighbors of node v, e.g., by Σ_{u∈N(v)}qᵤᵥxᵤ, add the features of node v (xᵥ), apply a linear transformation through the weight matrix C, and finally apply a non-linear activation function σ. It is noted, however, that the above function is merely one example of a function ƒ that can be utilized in connection with a GCN layer and that other functions could also be used.

Turning now to FIG. 3, a diagram depicting various GNN-related functions that can be performed by the conflict detector 120 of FIGS. 1-2 is illustrated. Repetitive description of like parts described above with regard to other implementations is omitted for brevity. As shown in FIG. 3, the conflict detector 120 includes an adjacency weighter 310 that can define connections between respective graph nodes, e.g., graph nodes generated for respective RAN applications 10 by an application grapher 110 as described above with respect to FIG. 1, according to an adjacency matrix. As will be described below, the adjacency matrix can be composed of adjacency values selected from a group of discrete states that correspond to types of potential conflicts (e.g., a direct conflict type, an indirect conflict type, or an implicit conflict type, as described above) between respective ones of the corresponding applications. The conflict detector 120 shown in FIG. 3 further includes a conflict probability estimator 320, which can estimate the probability that a given application will perform actions that conflict with those of another application based on the graph node connections determined by the adjacency weighter 310.

In an example implementation, neighboring nodes can be defined by the conflict detector 120 as shown in FIG. 3 based on the potential for direct, indirect, and implicit conflicts. To this end, the adjacency weighter 310 can utilize a weighted adjacency parameter W_{Edges[v]} that quantifies the likelihood of conflict between nodes, which can allow for nuanced detection of conflicts based on the type and/or intensity of potential interactions.

The adjacency weighter 310 can model potential conflicts using a non-binary weighted adjacency matrix with 2³=8 states for each weighted entry, where the weights are not just 0 or 1, e.g., indicating the absence or presence of an edge, but rather a range of 8 discrete states. These states can represent different levels or types of potential conflicts between nodes in the network, with each state assigned a specific weight value.

In an example implementation, the 8 different states noted above can emerge from three distinct types of conflicts: direct, indirect, and implicit. Each of these conflict types can exist or not for a given pair of applications, resulting in various combinations of conflicts and non-conflicts that make up the 8 states. For direct conflicts, the adjacency matrix can capture situations where a direct clash or competition exists between nodes. Indirect conflicts, on the other hand, can arise due to interdependencies or ripple effects between nodes, impacting each other indirectly. Finally, implicit conflicts can encompass scenarios where conflicts may not be explicitly stated but can still affect the network dynamics.

Given the complexity of implicit conflicts, where it is often uncertain whether they exist or not, the adjacency weighter 310 can initially assume the existence of implicit conflicts and assign them a specific state within the 8-state range. Continuous monitoring and analysis can enable the conflict detector 120 to update the adjacency matrix, particularly regarding implicit conflicts, ensuring that the conflict detection process accounts for evolving network dynamics and accurately represents the various conflict states.

For a given node, the conflict probability estimator 320 can utilize a GNN output function g(hᵥ,Xᵥ) to process the state vector h, in conjunction with node features Xᵥ, yielding an output oᵥ. This output can represent the probability of an application's actions leading to conflicting outcomes, thereby providing a predictive measure of conflict likelihood. The output function g(hᵥ,Xᵥ) used by the GNN model can be specifically formulated for conflict detection within a RAN environment, e.g., by combining the processed state vector hᵥ and the original features of a node Xᵥ to predict the likelihood of actions by an application (e.g., an xApp or rApp) leading to conflicts. While the specific form of g can vary depending on the GNN architecture used and the nature of the associated environment, one approach is to use one or more neural network layers that can process both hᵥ and Xᵥ together. By way of specific, non-limiting example, the following can be used:

oᵥ=σ(Wₒ·[hᵥ;Xᵥ]+bₒ),

where σ is a sigmoid activation function that ensures that the output oᵥ is a probability between 0 and 1; Wₒ is a weight matrix for the output layer; [hᵥ;Xᵥ] is the concatenation of the state vector hᵥ and the node features Xᵥ, forming the input to the output function; and bₒ is a bias term for the output layer.

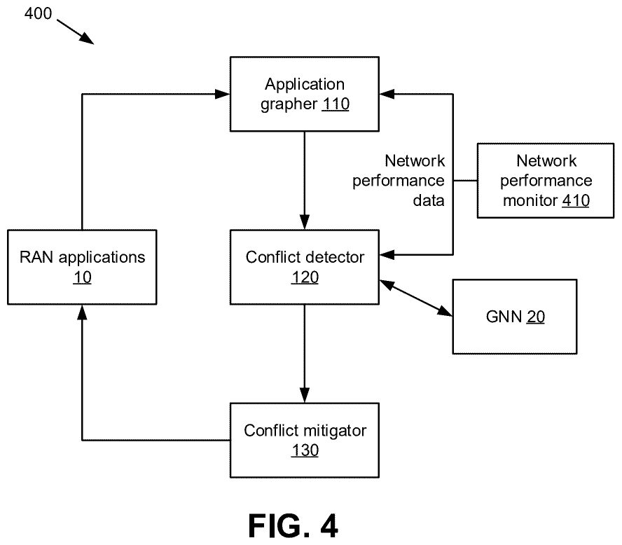

With reference now to FIG. 4, a block diagram of another system 400 that facilitates GNN-driven conflict detection is illustrated. Repetitive description of like parts described above with regard to other implementations is omitted for brevity. System 400 as shown in FIG. 4 includes an application grapher 110, a conflict detector 120, and a conflict mitigator 130, which can operate as described above with reference to FIG. 1. System 400 as shown in FIG. 4 further includes a network performance monitor 410, which can monitor KPIs and/or other performance metrics of a RAN in which the RAN applications 10 shown in FIG. 4 are utilized. In an example implementation, the network performance monitor 410 can trigger operation of the application grapher 110 and/or conflict detector 120 in response to detecting a degradation of the performance metrics of the RAN, e.g., of at least a threshold amount relative to baseline performance metrics of the RAN. In this way, the application grapher 110 and conflict detector 120 can be configured to operate only when network service degradation (e.g., due to a likely application conflict) is present, thereby reducing the resource usage associated with the application grapher 110 and conflict detector 120 in times in which application conflicts are less likely.

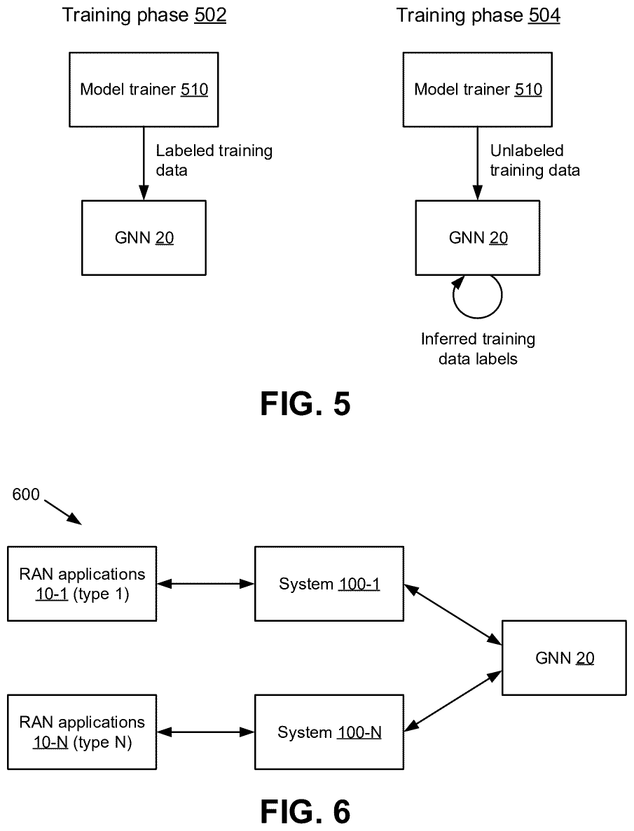

Moving now to FIG. 5, a diagram depicting a training procedure for a GNN 20, e.g., as performed by a model trainer 510 over a first training phase 502 and a second training phase 504, is provided. As shown in FIG. 5, the GNN 20 can be trained in the first training phase 502 using a first set of labeled training data. In the second training phase 504, the GNN 20 can be trained using a second set of unlabeled training data. During the second training phase 504, the GNN can infer labels for the unlabeled training data based on patterns learned by the GNN 20 from the set of labeled training data. The training procedure shown in FIG. 5 can enable the GNN 20 to refine various parameters utilized in conflict detection, such as the weight matrix Wₒ and bias term bₒ in the output function described above and/or other suitable parameters.

In general, the GNN 20 can be adapted to both supervised and semi-supervised learning paradigms, each of which can serve distinct purposes and offer unique advantages depending on the availability and nature of the data.

In supervised learning, the GNN 20 can be trained on a dataset where each data point (e.g., representing interactions among applications within a RAN environment) is labeled with a specific outcome (e.g., type of conflict or no conflict). These labels can serve as direct feedback for the model during the training process. The GNN 20 can use this dataset to learn the mapping between the input features (e.g., the structure of the graph, including nodes and edges that represent applications and their interactions, respectively) and the output labels (e.g., indicating the presence or absence of conflict and type of conflict when present).

Semi-supervised learning can be particularly beneficial when labeled data are scarce or expensive to generate, which can be a common scenario in complex systems such as O-RAN systems. In this paradigm, the GNN 20 can leverage both a small amount of labeled data and a larger pool of unlabeled data. Here, the labeled data can be used to guide the learning process initially (e.g., as in the first training phase 502 shown in FIG. 5), and then infer the labels for the unlabeled data based on the learned patterns and the graph structure (e.g., as in the second training phase 504 shown in FIG. 5).

Integrating supervised and semi-supervised learning can allow the GNN 20 to effectively learn from both the explicit guidance provided by labeled data and the implicit patterns present in unlabeled data. This hybrid approach can enhance the ability of the model to generalize from limited labeled examples to a broader range of scenarios, making it particularly powerful in dynamic and complex environments like O-RAN systems. It combines the strengths of both paradigms: the precision of supervised learning in mapping known patterns to outcomes, and the breadth of semi-supervised learning in leveraging large volumes of unlabeled data to uncover hidden structures and relationships.

The training process shown in FIG. 5 can be used to facilitate the implementation of GNN-based conflict detection in a RAN, which aims to effectively identify direct, indirect, and implicit conflicts among xApps and rApps (and/or other suitable RAN applications). The training process can leverage a range of data sources and methodologies. For instance, network simulators or digital twin models can provide a robust environment for training by simulating various network scenarios and conflict instances, enabling the GNN to learn from a diverse set of potential conflict patterns. Additionally, real-world data, such as logs from the physical network, can be used to fine-tune the model, ensuring that it is well-adapted to the intricacies and dynamics of actual network operations. This hybrid approach, encompassing both simulated and real-world data, can enhance the model's accuracy and generalizability in detecting and resolving conflicts in the RAN ecosystem.

Turning next to FIG. 6, a block diagram of still another system 600 that facilitates GNN-driven conflict detection is illustrated. Repetitive description of like parts described above with regard to other implementations is omitted for brevity. As shown in FIG. 6, system 600 can include multiple instances of system 100 as described above with reference to FIG. 1, here N systems 100-1 through 100-N, each of which can be associated with a different type or class of RAN applications 10, here N types of RAN applications denoted as 10-1 through 10-N. In an example implementation, the types of RAN applications 10-1 through 10-N can represent applications that perform on different timescales. Thus, for example, a first type of RAN applications 10 can be a non-RT type, a second type can be a near-RT type, and a third type can be a RT type. Other RAN application types are also possible.

Based on the system structure shown in FIG. 6, systems 100-1 through 100-N can determine, e.g., via a single shared GNN 20 and/or GNN instances that are individual to each system instance, conflict probabilities for multiple types or classes of RAN applications 10 in parallel. Thus, by way of example, system 100-1 can represent respective ones of a first type of RAN applications 10-1 as first graph nodes and first application feature sets, e.g., as described above with reference to FIG. 1, and, based on an output of the GNN 20 as applied to the first graph nodes and first feature sets, determine a first probability that a first one of the first type of RAN applications 10-1 will conflict with a second one of the first type of RAN applications 10-1, e.g., as further described above with reference to FIG. 1. Similarly, system 100-N can represent respective ones of a second type of RAN applications 10-N as second graph nodes and second application feature sets and, based on an output of the GNN 20 as applied to the second graph nodes and second feature sets, determine a second probability that a first one of the second type of RAN applications 10-N will conflict with a second one of the second type of RAN applications 10-N.

By implementing parallel systems 100-1 through 100-N as shown in FIG. 6, system 600 can facilitate multi-layer integration that permeates through the different temporal operational layers of the network, such as the non-RT, near-RT, and RT layers. Each of these layers has its specific role and response times for making decisions and managing the RAN, with the non-RT layer focusing on longer-term strategic decisions, the near-RT layer on millisecond-level control, and the RT layer on microsecond-level responses.

In this multi-tiered architecture, the GNN-based conflict detection system employed by systems 100-1 through 100-N can act as a unifying thread that stitches together the decision-making processes across these layers. At the non-RT layer, system 600 can analyze extensive historical data and long-term patterns to predict and prevent conflicts that may arise from planned network changes or scheduled maintenance activities. This predictive capability ensures that strategic decisions made at this level do not inadvertently lead to conflicts at the more immediate layers of near-RT and RT.

Moving into the near-RT layer, system 600 can leverage its real-time analytical prowess to provide quick conflict detection and resolution strategies that are desirable for the near-instantaneous demands of RAN control. It can react to live network conditions, adjusting resource allocations and controlling strategies on the fly to resolve conflicts before they escalate.

At the RT layer, the ability of the GNN 20 to process and analyze data at microsecond speeds enables it to offer immediate conflict resolution directives that can be of particular desirability during peak network usage times or in response to unforeseen network incidents.

The multi-layered integration of GNN-based conflict detection shown in FIG. 6 thus ensures that RICs and/or other network devices operate harmoniously, with a synchronized conflict resolution strategy that is cognizant of RAN dynamics across all operational layers. This holistic view not only enhances network efficiency and performance but also serves to preemptively address issues before they materialize, leading to more robust and reliable network operations.

Turning next to FIG. 7, an example network environment in which various implementations described herein can function is illustrated. M ore particularly, FIG. 7 illustrates an example integration of a GNN-based conflict detection engine into an O-RAN architecture that includes a service management and orchestration (SMO) platform as well as RICs running applications (xApps, rApps, etc.). Here, each xApp/rApp is conceptualized as a node within a graph, interacting with other nodes via a subscription management module and an associated software development kit (SDK), which facilitate data flow and control commands. The GNN-based conflict detection module sits at the heart of this architecture, processing control commands and subscription data to detect potential conflicts across the network.

FIG. 7 further illustrates data flows within the system, which show the bidirectional information exchange between xApps/rApps and the GNN module. This can include the transmission of control commands, subscription data (e.g., X_{sub} as described above), and adjacency information (e.g., W_{edges} as described above), which can be utilized by the GNN to understand and predict interactions between the xApps/rApps.

The GNN-based conflict detection module shown in FIG. 7 can utilize one or more algorithms as described above to analyze graph-structured data, allowing it to predict the probability of any xApp/rApp leading to opposite performance directions oᵥ. This can be achieved by learning from the features of each node, including targeted KPI categories, app classification, control levels, and/or other features, alongside the state vectors of neighboring nodes. To this end, the GNN-based conflict detection module can receive key performance metric (KPM) information and/or other data from the RAN as well as KPM information, event information, and/or other data from the xApps/rApps through an E2 interface (e.g., via an E2 terminator (E2T), as shown in FIG. 7).

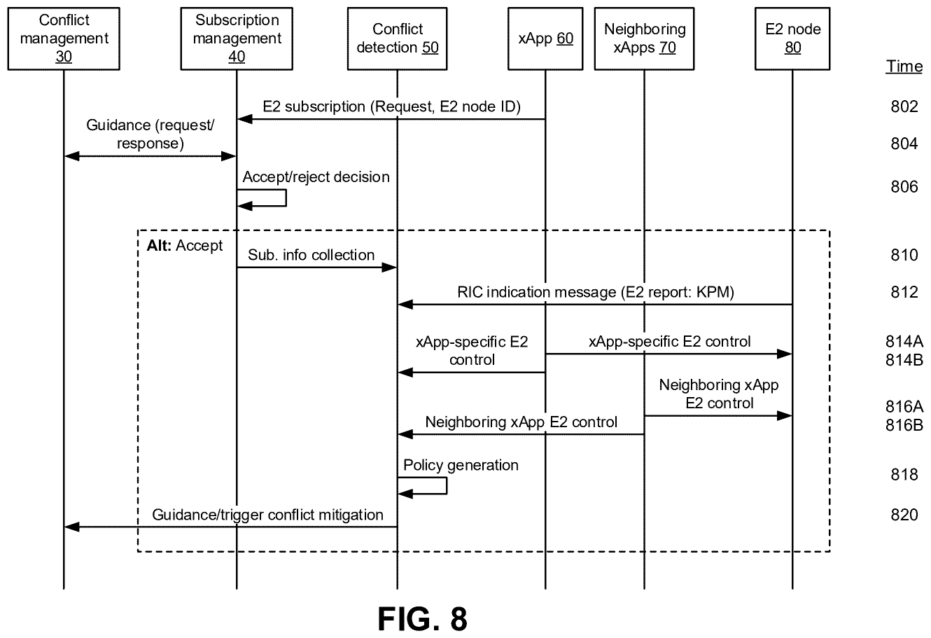

As will be described below with reference to FIG. 8, conflict detection as performed by the GNN-based conflict detection module can feed into a proactive conflict resolution system. For instance, upon detecting a potential conflict, the GNN-based conflict detection module can trigger policy generation and provide guidance for conflict mitigation, ensuring that the RICs can make informed decisions to harmonize the actions of the xApps/rApps.

By embedding the GNN-based conflict detection module directly within the operational framework of the RAN as shown in FIG. 7, enhanced performance, scalability, and adaptability can be achieved. Additionally, the real-time processing capabilities of the GNN ensure that the RAN can dynamically adjust to continuously changing network conditions, optimizing the performance of each xApp/rApp while preventing any detrimental conflicts.

With reference next to FIG. 8, a diagram illustrating an example procedure that can be utilized in connection with one or more implementations described herein is provided. As shown in FIG. 8, the procedure can be performed via one or more RAN elements, including a conflict management module 30 (e.g., that can implement some or all of the functionality of the conflict mitigator 130 as described above), a subscription management module 40, a conflict detection module 50 (e.g., that can implement some or all of the functionality of the application grapher 110 and/or conflict detector 120 as described above), an xApp 60 and its neighboring xApps 70, and an E2 node 80. It is noted that similar concepts to those shown in FIG. 8 could also be applied to different types of apps, including rApps and/or other suitable applications.

The procedure shown in FIG. 8 begins at time 802, at which the xApp 60 provides an E2 subscription request to the subscription management module 840. This request can include an E2 node identifier (ID) associated with the application as well as other subscription information, such as application category, control level, etc. At time 804, the subscription management module 40 can obtain conflict management guidance from the conflict management module 30 in response to the request from the xApp 60. Based on this guidance, the subscription management module 40 can then accept or reject the xApp subscription at time 806.

If the subscription management module 40 elects to reject the subscription at time 806, the procedure shown in FIG. 8 can conclude. Otherwise, if the xApp 60 is accepted, the procedure can continue as shown beginning at time 810, in which the subscription management module 40 provides subscription information associated with the xApp 60 to the conflict detection module 50. Additionally, at time 812, the E2 node 80 can provide a RIC indication message to the conflict detection module 50 that includes a system KPI report and/or other suitable information.

At time 814A, the xApp 60 can send xApp-specific control information to the E2 node 80. Concurrently or near concurrently, at time 814B, the xApp 60 can provide a copy of this control information to the conflict detection module 50. Similarly, neighboring xApps 70 can provide control information to the E2 node 80 and the conflict detection module 50 at times 816A and 816B, respectively.

At time 818, based on the KPI and/or other data received by the conflict detection module 50 at time 812 and the application control information received at times 814B and 816B, the conflict detection module 50 can undergo a policy generation procedure, e.g., in which the conflict detection module 50 can utilize a trained GNN to determine the probability of conflict for each of the xApps 60, 70, e.g., as generally described above. At time 820, based on the results of the policy generation at time 818, the conflict detection module 50 can send conflict management guidance to the conflict management module 30. This guidance can include, e.g., determined conflict probabilities for each of the xApps 60, 70 as well as preliminary conflict mitigation recommendations, if warranted based on the conflict probabilities. Based on this information, the conflict management module 30 can then take any suitable corrective actions, such as restricting the ability of one or more xApps 60, 70 to send commands via the RAN.

As described above, various example implementations provide for the integration of GNNs to model interactions within a RAN architecture. Traditional models often rely on flat, table-like structures where data points are independent and interactions are not inherently represented. This limitation becomes particularly evident in complex RAN environments where xApps/rApps operate in a deeply interconnected manner. GNNs, by design, embrace the complexity of these interactions, representing xApps/rApps and RAN components as nodes within a graph, with their interactions as edges. This graph-centric model can capture the multi-dimensional nature of relationships within the network, providing a holistic view of the system's dynamics.

In practical terms, ability of a GNN to understand and process graph-structured data allows for a more comprehensive analysis of how individual xApp/rApp strategies may conflict or synergize with one another. For instance, an xApp/rApp designed to optimize energy consumption may interact with another that prioritizes data throughput. A traditional flat data model might treat these objectives as separate, leading to potential conflict or suboptimal network performance. In contrast, a GNN can recognize that these objectives are not merely parallel but can be interdependent, with potential ripple effects throughout the network. This understanding can enable the GNN to forecast outcomes more accurately and suggest integrated solutions that address multiple objectives simultaneously.

Furthermore, a GNN framework as described above can be dynamic and capable of continual updates as the network evolves. This can be of particular desirability in an O-RAN setting where the network state is not static, e.g., user demands fluctuate, new devices connect, and service requirements change. The adaptability of the GNN ensures that it can adjust its understanding of the network as these changes occur, maintaining an up-to-date model that reflects the current state of the system. This continuous adaptation can enable an O-RAN system to be resilient and responsive to the ever-changing landscape of telecommunications. The graph structure of a GNN is inherently suited for such an environment, making it a foundational technology for the future of intelligent and autonomous network management.

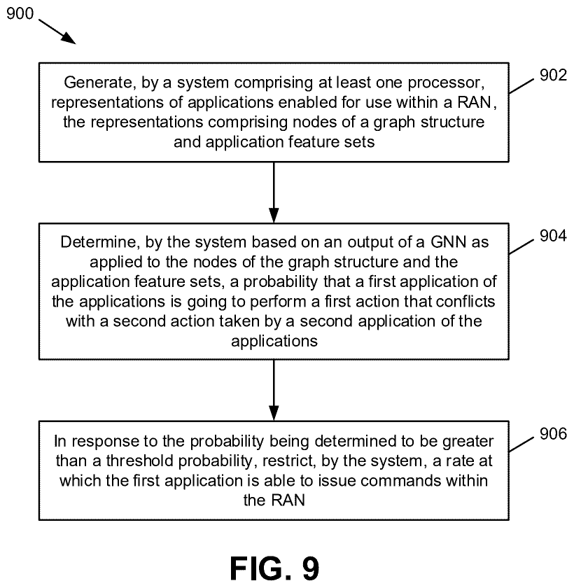

Referring now to FIG. 9, a flow diagram of a method 900 that facilitates GNN-driven conflict detection is illustrated. At 902, a system comprising at least one processor can generate (e.g., by an application grapher 110) representations of applications enabled for use within a RAN. These representations can include nodes of a graph structure and application feature sets.

At 904, the system can determine (e.g., by a conflict detector 120), based on an output of a GNN as applied to the nodes of the graph structure and the application feature sets as generated at 902, a probability that a first application of the applications is going to perform a first action that conflicts with a second action taken by a second application of the applications.

At 906, in response to the probability calculated at 904 being determined to be greater than a threshold probability, the system can restrict (e.g., by a conflict mitigator 130) a rate at which the first application is able to issue commands within the RAN.

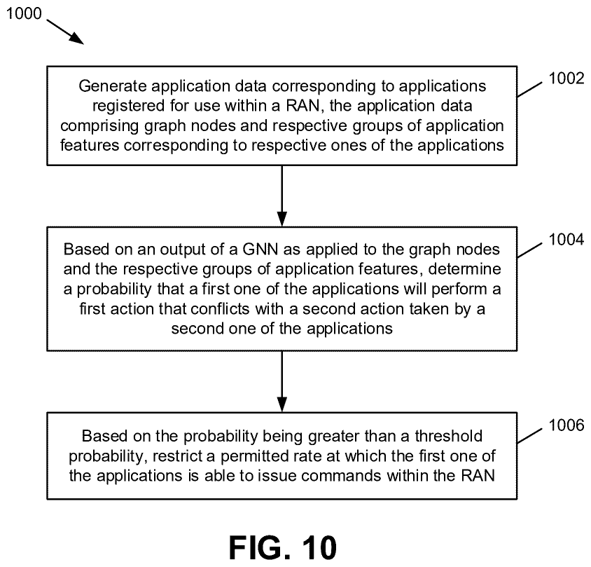

Referring next to FIG. 10, a flow diagram of a method 1000 that can be performed by at least one processor, e.g., based on machine-executable instructions stored on a non-transitory machine-readable medium, is illustrated. An example of a computer architecture, including a processor and non-transitory media, that can be utilized to implement method 1000 is described below with respect to FIG. 11.

Method 1000 can begin at 1002, in which the at least one processor can generate application data corresponding to applications registered for use within a RAN, the application data including graph nodes and respective groups of application features corresponding to respective ones of the applications.

At 1004, based on an output of a GNN as applied to the graph nodes and the respective groups of application features, the at least one processor can determine a probability that a first one of the applications will perform a first action that conflicts with a second action taken by a second one of the applications.

At 1006, based on the probability calculated at 1004 being greater than a threshold probability, the at least one processor can restrict a permitted rate at which the first one of the applications is able to issue commands within the RAN.

FIGS. 9-10 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 11 and the following discussion are intended to provide a brief, general description of a suitable computing environment 1100 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such a feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
representing respective ones of a group of applications enabled for use within a radio access network (RAN) as graph nodes and corresponding application feature sets;
based on an output of a graph neural network (GNN) as applied to the graph nodes and the application feature sets, determining a probability that a first application of the group of applications is going to perform a first action that conflicts with a second action taken by a second application of the group of applications; and
in response to the probability being determined to be greater than a threshold probability, restricting a rate at which the first application is able to issue commands within the RAN.

2. The system of claim 1, wherein the application feature sets comprise respective application descriptor data representative of respective properties of respective applications, respective lists of RAN control actions performable by the respective applications, and respective observed network performance metrics resulting from execution of the respective applications.

3. The system of claim 1, wherein the operations further comprise:
generating a state vector for an application of the group of applications by performing a latent space transformation on an application feature set, of the application feature sets, corresponding to the application.

4. The system of claim 3, wherein the state vector relates the application to other applications, of the group of applications and other than the application, based on a determined potential for conflicts between the application and the other applications.

5. The system of claim 1, wherein the operations further comprise:
monitoring performance metrics of the RAN, wherein the determining of the probability is in response to detecting a degradation of the performance metrics of the RAN by at least a threshold amount relative to baseline performance metrics of the RAN.

6. The system of claim 1, wherein the operations further comprise:
defining connections between respective ones of the graph nodes according to an adjacency matrix, the adjacency matrix comprising adjacency values selected from a group of discrete states corresponding to types of potential conflicts between the respective ones of the group of applications.

7. The system of claim 6, wherein the types of the potential conflicts comprise a direct conflict type, corresponding to first requests of the first application that specify conflicting settings for a common RAN control target, an indirect conflict type, corresponding to second requests of the first application having conflicting effects on a first system metric, and an implicit conflict type, corresponding to third requests of the first application associated with a second system metric that cause degradation to a third system metric that is not the second system metric.

8. The system of claim 1, wherein the group of applications comprises applications that are of a common application type selected from a group of application types comprising a non-real time application type, a near-real time application type, and a real time application type.

9. The system of claim 8, wherein the group of applications is a first group of applications, wherein the common application type is a first common application type, wherein the graph nodes are first graph nodes, wherein the application feature sets are first application feature sets, wherein the output of the GNN is a first output, wherein the probability is a first probability, and wherein the operations further comprise:
representing respective ones of a second group of applications, enabled for use within the RAN and of a second common application type selected from the group of application types that is not the first common application type, as second graph nodes and corresponding second application feature sets; and
based on a second output of the GNN as applied to the second graph nodes and the second application feature sets, determining a second probability that a third application of the second group of applications is going to perform a third action that conflicts with a fourth action taken by a fourth application of the second group of applications.

10. The system of claim 1, wherein the operations further comprise:
training the GNN using a first set of labeled training data and a second set of unlabeled training data, the training comprising inferring, via the GNN, labels for the second set of unlabeled training data based on patterns learned by the GNN from the first set of labeled training data.

11. The system of claim 1, wherein the respective ones of the group of applications are associated with respective RAN intelligent controllers.

12. A method, comprising:
generating, by a system comprising at least one processor, representations of applications enabled for use within a radio access network (RAN), the representations comprising nodes of a graph structure and application feature sets;
determining, by the system based on an output of a graph neural network (GNN) as applied to the nodes of the graph structure and the application feature sets, a probability that a first application of the applications is going to perform a first action that conflicts with a second action taken by a second application of the applications; and
in response to the probability being determined to be greater than a threshold probability, restricting, by the system, a rate at which the first application is able to issue commands within the RAN.

13. The method of claim 12, further comprising:
generating, by the system, a state vector for an application of the applications, the generating of the state vector comprising performing a latent space transformation on an application feature set of the application feature sets that corresponds to the application.

14. The method of claim 13, wherein the state vector relates the application to other applications, of the applications and other than the application, based on a determined potential for conflicts between the application and the other applications.

15. The method of claim 12, further comprising:
defining, by the system, connections between respective ones of the nodes of the graph structure according to an adjacency matrix, the adjacency matrix comprising adjacency values selected from a group of discrete states corresponding to types of potential conflicts between respective ones of the applications.

16. The method of claim 12, further comprising:
training, by the system, the GNN using a first set of labeled training data and a second set of unlabeled training data, the training comprising inferring, via the GNN, labels for the second set of unlabeled training data based on patterns learned by the GNN from the first set of labeled training data.

17. A non-transitory machine-readable medium comprising computer executable instructions that, when executed by at least one processor, facilitate performance of operations, the operations comprising:
generating application data corresponding to applications registered for use within a radio access network (RAN), the application data comprising graph nodes and respective groups of application features corresponding to respective ones of the applications;
based on an output of a graph neural network (GNN) as applied to the graph nodes and the respective groups of application features, determining a probability that a first one of the applications will perform a first action that conflicts with a second action taken by a second one of the applications; and
based on the probability being greater than a threshold probability, restricting a permitted rate at which the first one of the applications is able to issue commands within the RAN.

18. The non-transitory machine-readable medium of claim 17, wherein the operations further comprise:
generating a state vector for an application of the applications, the generating of the state vector comprising performing a latent space transformation on a group of application features, of the respective groups of application features, that corresponds to the application.

19. The non-transitory machine-readable medium of claim 17, wherein the operations further comprise:
defining connections between respective ones of the graph nodes according to an adjacency matrix, the adjacency matrix comprising adjacency values selected from a group of discrete states corresponding to types of potential conflicts between respective applications of the applications.

20. The non-transitory machine-readable medium of claim 17, wherein the operations further comprise:
training the GNN using a first set of labeled training data and a second set of unlabeled training data, the training comprising inferring, via the GNN, labels for the second set of unlabeled training data based on patterns learned by the GNN based on the first set of labeled training data.
